(19) United States
(12) Patent Application Publication
(10) Pub. No.: US 2013/0015221 A1
(43) Pub. Date: Jan. 17, 2013

(54) ADJUSTABLE HI-LOW HITCH MOUNTED CARGO CARRIER

(71) Applicant: Marty Williams, Colorado Springs, CO (US)

(72) Inventor: Marty Williams, Colorado Springs, CO (US)

(21) Appl. No.: 13/352,315

(22) Filed: Jan. 17, 2012

Related U.S. Application Data
(63) Continuation-in-part of application No. 09/683,820, filed on Feb. 20, 2002, now abandoned.

(51) Int. Cl. B60R 9/06; B23P 11/00

(52) U.S. Cl. 224/510; 29/525.01

(57) ABSTRACT

A hi-low cargo carrier for mounting onto a vehicle that provides easily adjustable ground to cargo carrier clearance, where the cargo carrier has a connection frame and a carrier frame with the connection frame attached to the vehicle and the carrier frame connected to the connection frame using tubes that engage over the connection frame tubes.

### BACKGROUND OF INVENTION

The Current Application is a Continuation-In-Part of previously filed U.S. patent application Ser. No. 09/683,820 the contents of which are incorporated herein by this reference. The use of cargo carriers mounted to vehicles are very popular for traveling, for carrying sports equipment and even for hauling light cargo. Typically these carriers are designed to mount on the hitch receiver of a vehicle, such as a passenger car, sports utility vehicle, van or even pickup trucks. These cargo carriers include a member that is inserted into the receiver hitch or even mounted onto the hitch ball of the vehicle. These cargo carriers are normally mounted closely adjacent to the rear of the vehicle in order to reduce the torque loading on the rear of the vehicle that can create difficulties in the handling and performance of the vehicle.

One problem that results from the use of such cargo carriers is the inability to access the rear of the vehicle. Most such vehicles have a tailgate or door that swings down, up or sideways to allow access into the rear of the vehicle. Since most cargo carriers are mounted closely to the rear of the vehicle, this access is denied. Many such cargo carriers must be dismounted from the vehicle to allow access into the vehicle.

Another problem is that all currently available cargo carriers have a fixed height. That is, they are not adjustable height-wise. If the carrier is attached to a car the carrier tends to sit relatively low to the ground and alternatively, when attached to a truck or a vehicle that has been lifted the carrier tends to be quite high, thus making it difficult to add or remove gear and ultimately quite inconvenient. There is a significant need for a system that can be raised or lowered and that still provides stability and performance.

There have been a number of attempts to solve these problems. For example, with respect to the first problem, carriers that are slidable or telescoping relative to the hitch mount are disclosed in U.S. Pat. Nos. 5,586,702 and 5,881,937, both issued to Sadler. Other such types of cargo carriers are disclosed in U.S. Pat. No. 5,310,100, issued to Liscinsky; U.S Pat. No. 5,570,825, issued to Coma; U.S. Pat. No. 6,145,720, issued to Comeau; and U.S. Pat. No. 6,152,341 issued to LeMay et al. Also, these patents and others, including U.S. Pat. No. 4,744,590 issued to Chesny and U.S. Pat. No. 5,224,636, issued to Bounds disclose cargo carriers that pivot downwardly to allow access into the vehicle.

These structures have varying amounts of success. However, they all include common elements of a single carrier tube that slides within or relative to the hitch receiver. The carrier tube may also include an intermediate connection member as well. The carrier tube and/or the intermediate connection member are always formed of square tubing or bars. This creates a number of problems with the use of such carriers.

One such problem is the sway of the carriers relative to the single carrier tube. This is particularly pronounced if the carrier is imbalanced from the load within the carrier. The load creates a moment along the upper surface of that single carrier tube that not only causes the carrier to sway, but can also detrimentally impact the handling and performance of the vehicle.

Another problem with these types of carriers is the friction between the rectangular tubing or bars. The carrier tube or connection member, in the previous carriers, slide within the hitch receiver or intermediate connection member. Since these are substantially rectangular, there is a substantially amount of friction to be overcome. This can cause difficulty in moving loaded carriers. This is further exacerbated by the tightness of the fit between the hitch receiver and the carrier tube. This tightness is necessary in order to reduce the relative movement or “slop” between the hitch receiver and the carrier. Failure to reduce the relative movement can cause the carrier to sway relative to the vehicle impacting the handling and performance of the vehicle.

Another problem with the use of the prior carriers is that the shape and configuration of the connection tubes or bars causes the load to be concentrated on certain parts of the hitch receiver and/or connection members. This necessitates overdesign of these members, thus increasing the weight, size and cost of the carriers.

These and other problems have created a need for hitch mounted carriers that are more efficient, more stable, and easier to use.

### SUMMARY OF INVENTION

The present invention solves these problems and others by providing a stable frame that enables the cargo container to be moved relative to the vehicle while still maintaining stability of the container in use. The frame also enables easier movement of the cargo container. Also, the overall weight of the carrier frame is reduced while improving the stability and strength of the carrier frame. Finally, the present invention provides for a cargo container frame with adjustable height.

In one preferred embodiment, the cargo carrier includes a connection member or spine that is secured to the vehicle. Two parallel cylindrical tubes extend from the connection member. A carrier frame includes opposing tubes that engage over the connection member tubes. This enables the carrier frame to slide on the connection member tubes fully supported. Fasteners can secure the carrier frame from movement for travel. The use of the cylindrical tubes reduces the friction of the movement while maintaining the integrity of the structure. The use of more than one tube minimizes the sway of the cargo container.

In other embodiments, the connection tubes are mounted to pivot relative to the connection tube. This enables the carrier frame to pivot out of the way to allow access to the rear of the vehicle.

Another embodiment uses an open channel with rollers to allow the carrier frame to move relative to the connection frame. Also, “C” shaped tubes are also able to be used.

These features and others will be evident from the detailed description of preferred embodiments, the claims and the drawings.

### BRIEF DESCRIPTION OF DRAWINGS

FIG. 1 is an illustration of a cargo box mounted to the rear of a vehicle.

FIG. 2 is an exploded illustration of the cargo carrier of a preferred embodiment of the present invention.

FIG. 3 is a view of the assembled cargo carrier of the embodiment of FIG. 2.

FIG. 4 is a view of the cargo carrier of the embodiment of FIG. 2 mounted to the hitch receiver of a vehicle.

FIG. 5 is an illustration of the cargo carrier of FIG. 4 moved to a rearward position relative to the vehicle.

FIG. 6 is an exploded illustration of an alternative embodiment.

FIG. 7 is an exploded illustration of another alternative embodiment.

FIG. 8 is an exploded illustration of another alternative embodiment.

FIG. 9 is an exploded illustration of another alternative embodiment.

FIG. 10 is a cross-section of the embodiment of FIG. 9 taken along lines A-A.

FIG. 11 is a view of the assembled cargo carrier of the embodiment of FIG. 12 when used in the low position.

FIG. 12 is an exploded illustration of the cargo carrier of a preferred embodiment of the present invention when used in the low position.

### DETAILED DESCRIPTION

The present invention provides a hitch mounted cargo carrier apparatus that solves many of the problems of the prior cargo carriers. In a preferred embodiment of the present invention, a connection apparatus for mounting not only cargo carriers, but other types of hitch mounted devices to a vehicle is provided. It is to be expressly understood that the descriptive embodiments provided herein are for explanatory purposes only and are not meant to unduly limit the scope of the present invention. Other embodiments and modifications are considered to be within the scope of the claimed invention.

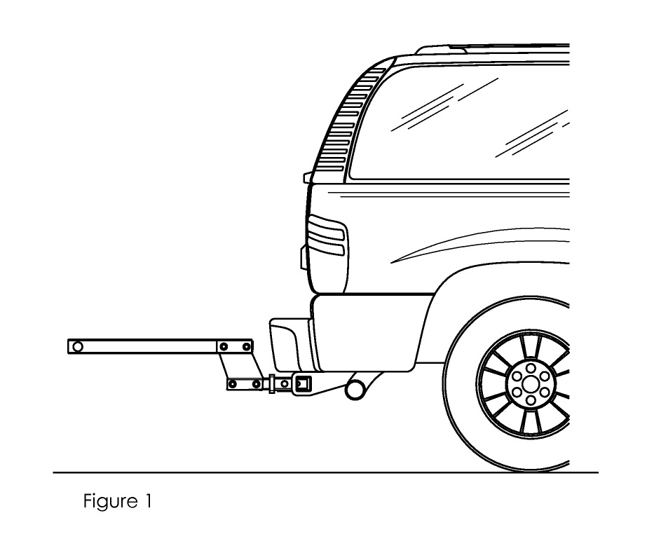

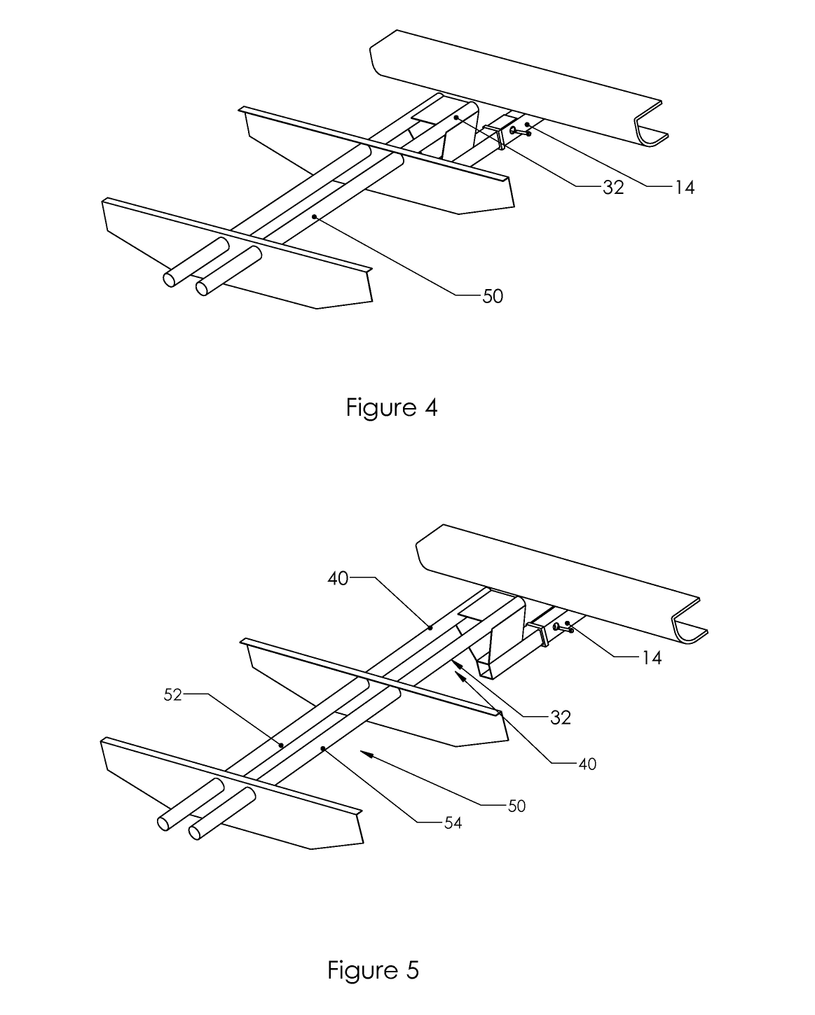

In one preferred embodiment of the present invention illustrated in FIGS. 1 and 3, a cargo carrier 20 is mounted on a vehicle 10. Cargo carrier 20 includes a cargo box 22 and a frame 30. It is to be expressly understood that the cargo box 22 does not form any part of the present invention. Other types of carriers could be used, such as platforms, bicycle racks, etc.

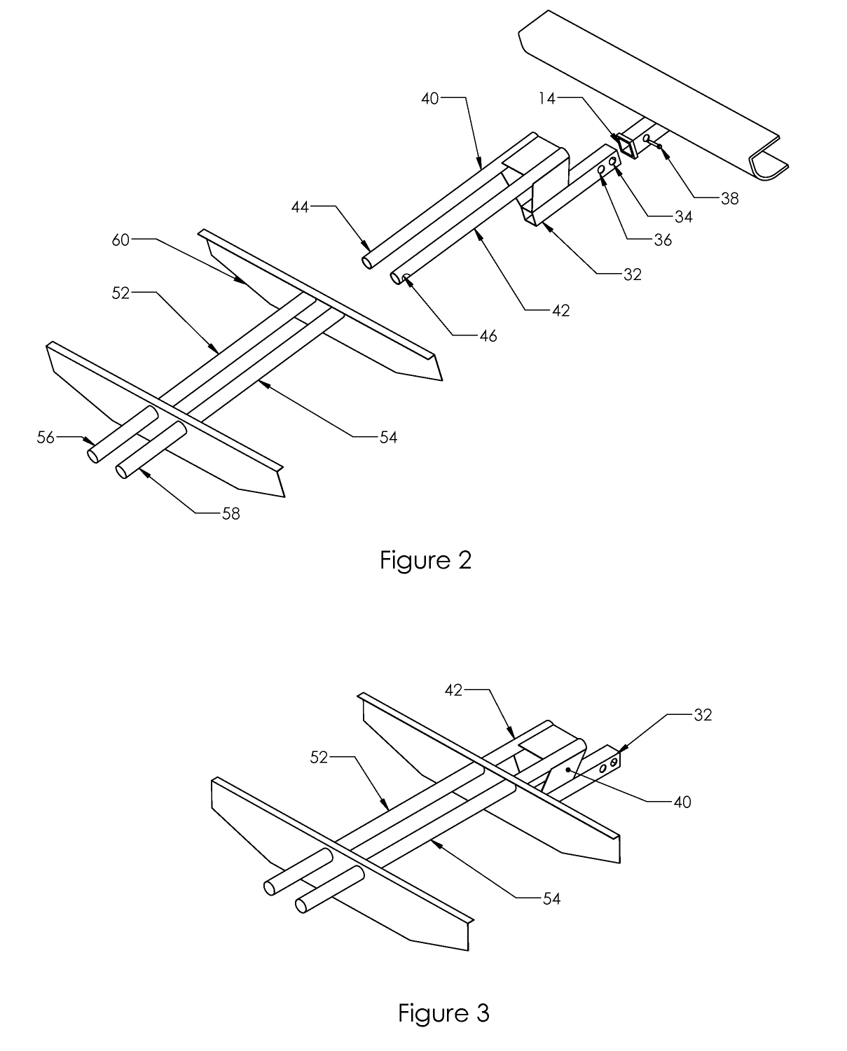

As shown in FIG. 2, connection frame 30 includes connection member 32 having holes 34, 36 for receiver hitch pin 38. Connection member 32 also includes two parallel longitudinally extending connection mounts, or circular tubes 40, 42. In the embodiment illustrated in FIG. 2, the circular tubes 40, 42 are separated from connection member 32 by separation member 48 such that the tubes are configured in a raised manner above the connection member 32. However, the tubes 40, 42 could also be positioned on top of, below or alongside of connection member 32. This is accomplished by simply inserting connection member 32 into the hitch receiver in a differing manner. The circular tubes 40, 42 extend a length substantially equal to the length of the carrier frame 50, although this is not necessarily required. The length could be longer or shorter as desired. Fastener holes 44, 46 are formed in the circular tubes 40, 42 along the length of the tubes. The connection mounts can be tubes 40, 42 and these tubes may be hollow or solid.

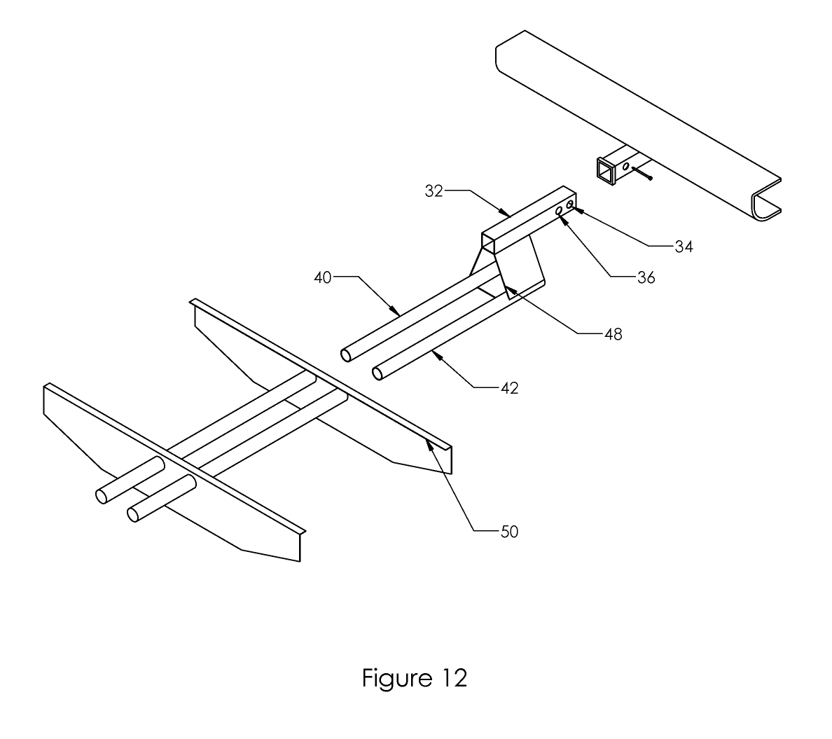

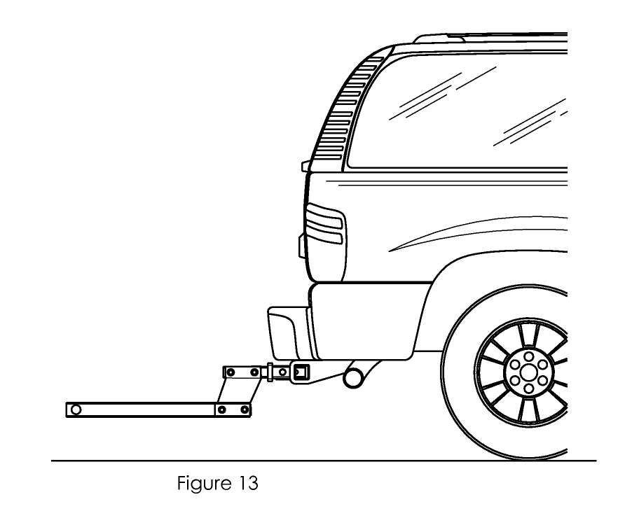

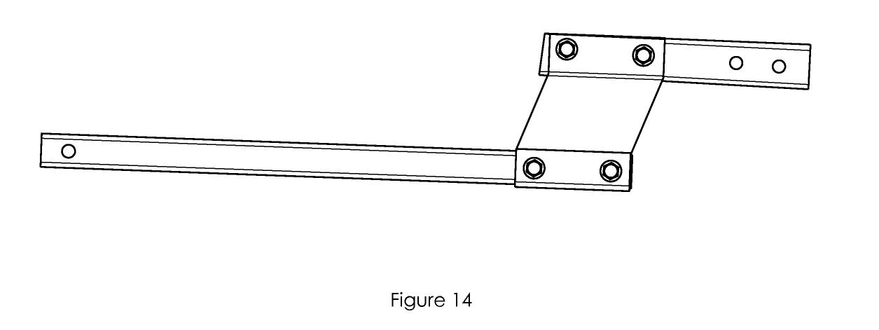

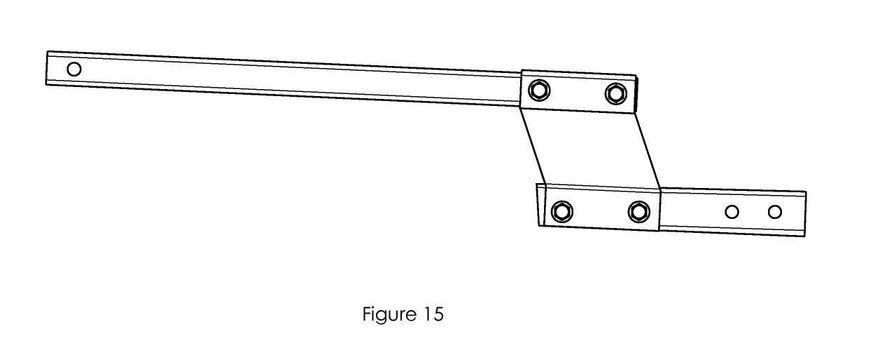

As noted above, the tubes 40, 42 may be positioned below of or alongside of connection member 32. The embodiment where the tubes are positioned below connection member 32 is more clearly shown in FIGS. 11 and 12. This configuration is possible because of the unique structural design of connection frame 30. This design provides additional convertibility and adjustability of connection frame 30. Connection frame 30 has three main components; a main connection member 32 that is inserted into the hitch receiver 14; a separation member 48 connected to the connection member 32; and a first connection mount and a second connection mount connected to the separation member 48. Because of this configuration the connection mounts can be used in either an elevated or lowered position depending on how connection member 32 is inserted into hitch receiver 14. Both insertion methods are shown in FIGS. 2 and 3 and in the alternative position in FIGS. 11 and 12. Thus, Connection member 32 can be inserted into the hitch receiver 14 so that the connection mounts are elevated or, in the alternative, connection member 32 can be inserted so that connection mounts 40, 42 are in a lowered position, as shown in FIGS. 11 and 12. This versatility is extremely important when the system is used with a vehicle that has been lifted or even when used with a vehicle that has lots of ground clearance because when in the lowered position the cargo system is more easily accessible, as is shown in FIG. 11. This alternating position is also important when used with a car or a vehicle that has been lowered, thus providing better ground clearance for the cargo carrier. Additionally, this is extremely important for handicapped individuals as it provides a way to lower the platform for ingress and egress of mobility scooters, wheelchairs and powered wheelchairs,

This dual configuration is made possible because of the adjustable insertability of connection member 32 into hitch receiver 14 and because of the adaptability of carrier frame 50. Carrier frame 50 is designed so that it can effectively slide onto mounts 40 and 42 when the mounts are in either the elevated or lowered position. This configuration and adjustability provides the user with extensive height adjustment that is extremely useful when dealing with vehicles of differing ground clearance. Obviously, as mentioned above, when a vehicle is lower to the ground, such as in a car, it is useful to have the frame elevated and alternatively, when used with a raised vehicle it is useful to have the frame lowered to provide easier access . Also as already noted, this is extremely important for use with mobility scooters, wheelchairs and powered wheelchairs for handicapped individuals. It should be clear that this reversed configuration is entirely possible with any of the alternative embodiments described and shown herein.

Frame 50, as shown in FIG. 2, a preferred embodiment includes two receiving tubes 52, 54 having inner dimensions and shape similar to the outer dimensions and shape of the two parallel tubes 40, 42. Tubes 52, 54 are mounted to be able to mount over the tubes 40, 42. It is to be expressly understood that tubes 52, 54 and tubes 40, 42 could be reversed, that is, the tubes 52, 54 could slide into the tubes 40, 42 or alternatively, one tube could slide into the opposing tube while the other adjacent tube could slide over the opposing tube. Fastening holes 56 and 58 are formed in tubes 52, 54 in a location to match the fastener holes 44, 46 when the carrier body frame 50 is securely mounted onto the tubes 40, 42. It is not necessary that the mounts be tubes at all, but rather could be any means of mounting frame 50.

Carrier frame 60 also includes support members 60, 62 extending transversely from the tubes 52, 54. A cargo carrier or other apparatus can be secured onto the support members 60, 62 by well-known mechanism.

In use, the carrier frame 50 is mounted onto the connection member 32 by inserting tubes 52, 54 over mounts 40, 42 (or as discussed above). Once the carrier frame 50 is securely and fully engaged onto the connection member 32, fasteners are inserted through holes 56, 44 and 58, 46, respectively to secure the carrier body frame 50 onto the connection member 32. Connection member 32 is (or already has been) inserted into the hitch receiver 14 of the vehicle 10. Fastener 38 is inserted through the hitch receiver 14 and through one of the holes 34, 36. A cargo carrier can be fastened (or already has previously been fastened) onto the carrier frame 50.

Once the carrier frame 50 and connection member 32 has been secured, the carrier 20 is ready for use. The twin tube system (40, 42, and 52, 54) provides secure support for the cargo and minimizes sway of the cargo carrier. If access is desired for the rear of the vehicle, then the fasteners are removed from fastener holes 44, 56, and 46, 58 and the carrier frame is slid backwards relative to the connection member 32 and mounts 40, 42 as shown in FIG. 5. The shape and size of the mounts 40, 42 and 52, 54 reduce the friction from this movement and also provides a smoother more effortless movement. When access to the rear of the vehicle is no longer needed, then the carrier frame is returned to its original position and the fasteners reinserted.

The carrier 20 also enables the quick change of cargo devices. For example, several different cargo frames 50 may have different equipment or devices secured thereto. The use of the connection frame as discussed above enables the quick change of these different frames onto the connection frame.

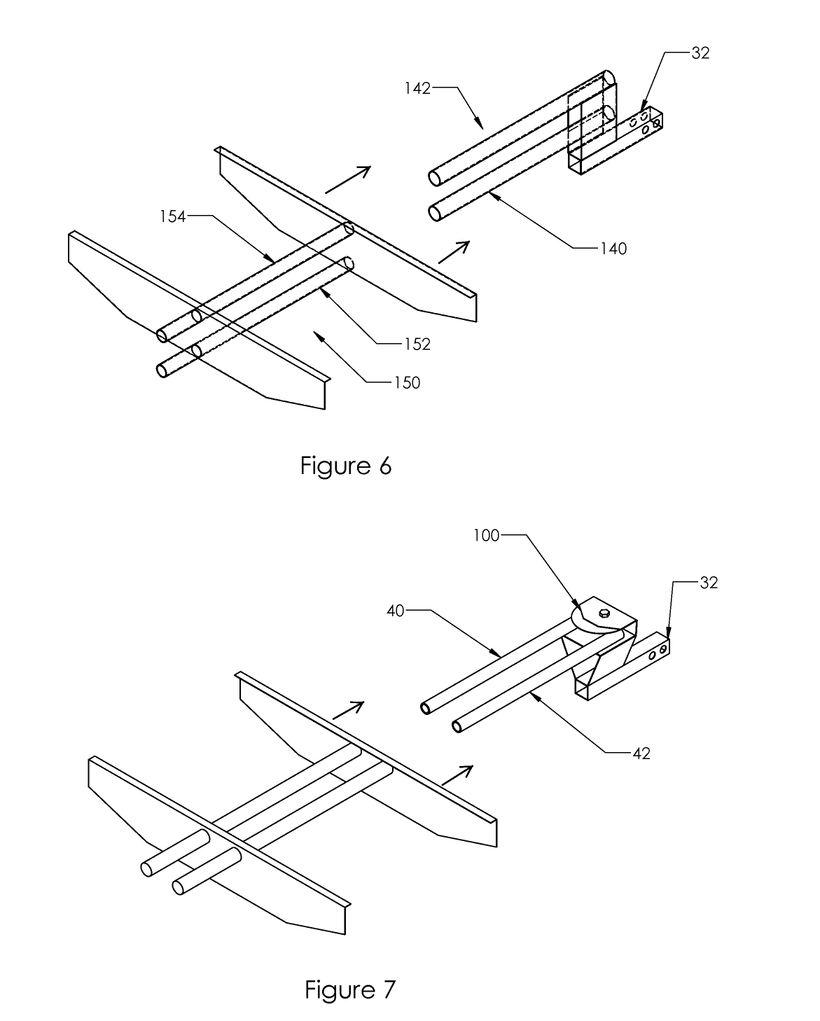

Another embodiment is illustrated in FIG. 6. This embodiment is similar to the above embodiment, except that the two parallel mounts 140,142 are spaced vertically as opposed to horizontally. Similarly, the two parallel tubes 152, 154 are also spaced vertically to one another. The operation of the carrier frame 50 and the connection member 32 remains the same.

Another embodiment is illustrated in FIG. 7. This embodiment is similar to the embodiment illustrated in FIGS. 2 5 except that the carrier frame is horizontally pivotable relative to the vehicle to allow access to the vehicle. Hinge pivot 100 is mounted to connection member 32 and may be pivoted horizontal relative to connection member 32. A locking pin (not shown) locks the hinge pivot 100 to prevent accidental movement of the hinge pivot and carrier frame 50. Mounts 40, 42 are mounted to the hinge pivot 100. The carrier frame 50 is then mounted on the mounts 40, 42 in a manner as discussed above. The locking pin is simply removed to allow the carrier frame 50 and any cargo carrier mounted onto it to be pivoted in either direction.

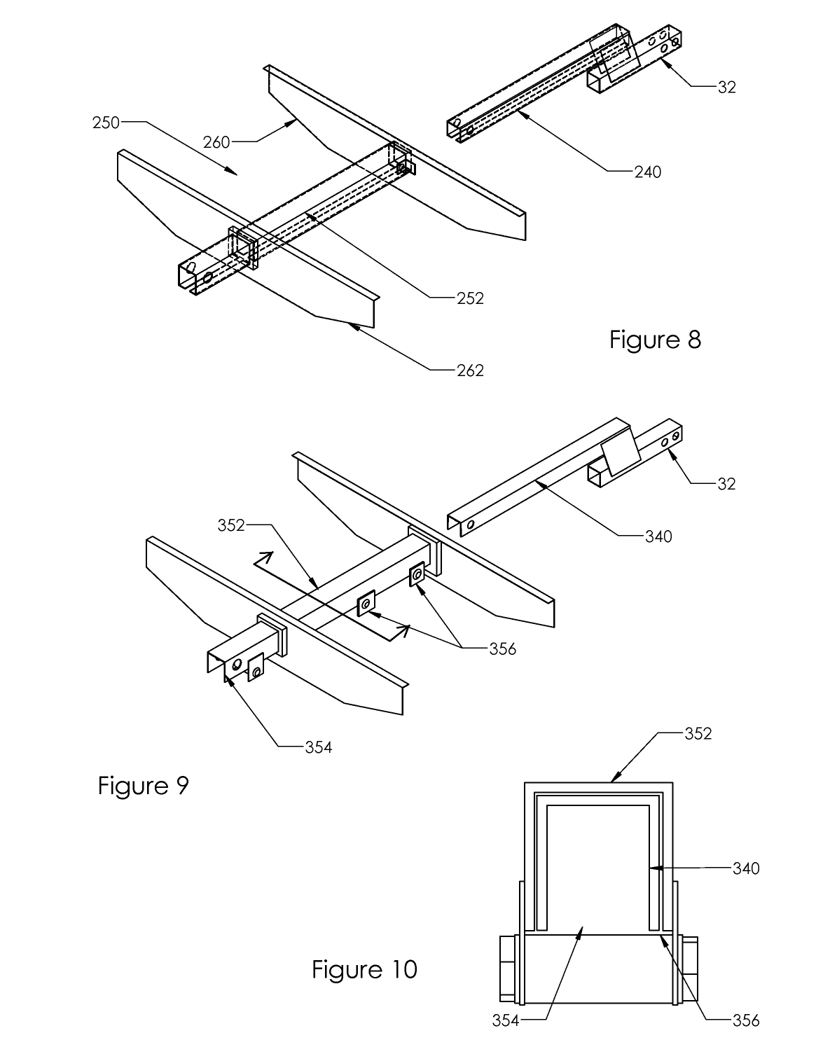

An alternative embodiment is shown in FIG. 8. This embodiment is similar to the first described embodiment except that the twin carrier tube design is not used. Instead, a “C” channel member 240 is secured to the connection member 32. Carrier frame 250 includes a mating “C” channel 252 that slides over and engages channel member 240. Support members 260, 262 are secured to channel member 252 for supporting a cargo container or other device. The carrier frame 250 is mounted to the vehicle by sliding channel member 252 over (or into) channel member 240. A fastener is inserted through holes 242 and 252 to secure the carrier frame in place. The carrier frame 250 can be easily slid backwards once the fastener is released to allow access into the rear of a vehicle onto which the cargo apparatus is mounted. The channel member 240 can also be mounted to pivot relative to the connection member 32 as discussed in the embodiment of FIG. 7.

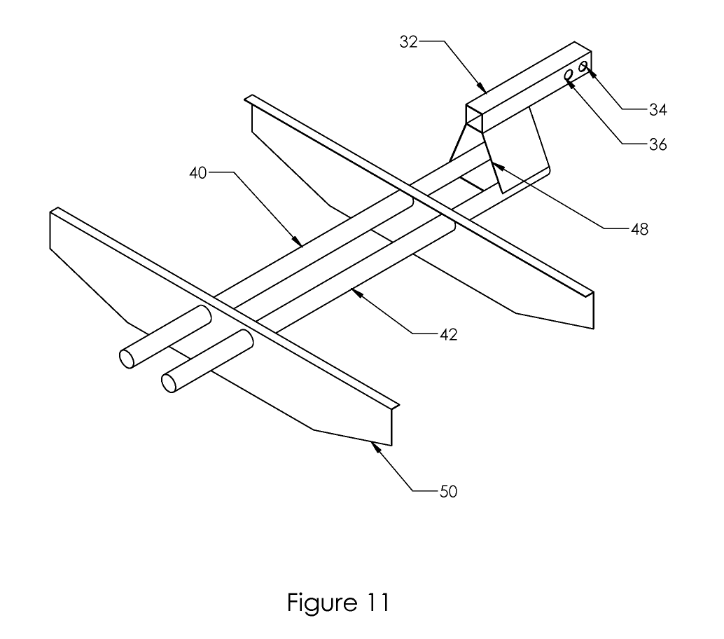

Another alternative embodiment is illustrated in FIGS. 9 and 10. An open channel member 340 is secured to connection member 32. Open channel member 340 includes a bottom opening extending the length of the channel member. Alternatively the bottom opening of channel member 340 could be partially or entirely closed. However, carrier frame member 352 includes a bottom opening 354 extending substantially the length of the member 352. One or more rollers 356 are mounted adjacent the bottom opening 354, as shown in FIGS. 9 and 10. As the carrier frame member 352 is mounted and/or slid over the channel member 340, the rollers provide support and also reduce friction during the movement. The carrier frame member can be locked into place on the connection member 32 by the use of a fastener extending through holes 344, 358.

These and other embodiments are included in the present invention as set forth in the ensuing claims. It is to be expressly understood that these descriptive embodiments are intended for explanatory purposes only and are not meant to limit the scope of the appended claims.

What I claim is:

1. A cargo carrier for mounting to the rear of a vehicle, said cargo carrier comprising:
a connection frame for mounting onto a vehicle where said connection frame comprises;
a connection member;
a separation member;
a first connection mount and;
a second connection mount adjacent thereto;
a carrier frame comprising;
a first carrier member having an inner dimension substantially similar to an outer dimension of said first connection mount such that said first carrier member can slide over said first connection mount;
a second carrier member having an inner dimension substantially similar to an outer dimension of said second connection mount such that said second carrier member can slide over said second connection mount; and
at least one fastener for securing said carrier frame to said connection member to prevent movement.

2. The cargo carrier of claim 1 wherein said first connection mount and said second connection mount are substantially cylindrical.

3. The cargo carrier of claim 1 wherein said first connection mount and said second connection mount are substantially parallel to one another.

4. The cargo carrier of claim 1 wherein said first connection mount and said second connection mount are substantially horizontally parallel to one another.

5. The cargo carrier of claim 1 wherein said connection frame includes more than two connection mounts and said cargo frame includes an equal number of carrier members for engagement with said connection mounts.

6. The cargo carrier of claim 1 wherein at one surface of said carrier member has an open channel.

7. The cargo carrier of claim 6 wherein said carrier member including at least one roller mounted adjacent said open channel on said carrier tubes.

8. A method of adjusting a ground to cargo carrier height of the cargo carrier of Claim one comprising the steps of:
inserting said connection member into a vehicle hitch receiver such that said separation member extends upwardly to create greater ground to cargo carrier clearance or;
inserting said connection member into said vehicle hitch receiver such that said separation member extends downwardly to create lesser ground to cargo carrier clearance;
sliding said carrier members over said carrier mounts; and
fastening said fasteners for securing said carrier frame to said connection member.
